(19) United States
(12) Patent Application Publication
(10) Pub. No.: US 2013/0049942 A1
(43) Pub. Date: Feb. 28, 2013

(54) METHOD FOR CONTROLLING ACCELERATOR PEDAL OF HYBRID VEHICLE

(71) Applicants: Eunsik Kim, Daegu (KR); Jeongseon Min, Hwaseong-si (KR); Yangrae Cho, Hwaseong-si (KR)

(72) Inventors: Eunsik Kim, Daegu (KR); Jeongseon Min, Hwaseong-si (KR); Yangrae Cho, Hwaseong-si (KR)

(73) Assignee: Hyundai Motor Company, Seoul (KR)

(21) Appl. No.: 13/295,898

(22) Filed: Nov. 14, 2011

(30) Foreign Application Priority Data
Aug. 30, 2011 (KR) 10-2011-0087246

(51) Int. Cl. B60L 15/00; B60Q 1/00; G05G 1/30

(52) U.S. Cl. 340/438; 701/22

(57) ABSTRACT

A method for controlling an accelerator pedal of a hybrid vehicle includes determining a switching state of a driving mode of the hybrid vehicle, and applying a different manipulation feeling to the accelerator pedal, when it is determined that the driving mode was switched. When the driving state of the hybrid vehicle is switched from an electric motor to an engine or from the engine to the electric motor, a driver may easily recognize the switching of the driving state.

### CROSS-REFERENCE TO RELATED APPLICATIONS

The present application claims priority to Korean Patent Application Number 10-2011-0087246 filed Aug. 30, 2011, the entire contents of which application is incorporated herein for all purposes by this reference.

### BACKGROUND OF INVENTION

1. Field of Invention

The present invention relates to a method for controlling an accelerator pedal of a hybrid vehicle, and more particularly, to a method for controlling an accelerator pedal of a hybrid vehicle, which increases a pedal effort of an accelerator pedal or applies a vibration to the accelerator pedal when a driving state of the hybrid vehicle is switched from an electric motor to an engine or from the engine to the electric motor, such that a driver easily recognizes the switching of the driving state of the vehicle.

2. Description of Related Art

A hybrid vehicle according to the related art includes an electric motor and an engine which are mounted as power sources to drive the vehicle. Depending on the driving state of the vehicle, the electric motor or the engine is used to drive the vehicle.

When the hybrid vehicle is driven by the electric motor, vehicle interior noise becomes small, because the driving noise of the electric motor is small. On the other hand, when the hybrid vehicle is driven by the engine, the vehicle interior noise increases, because the driving noise of the engine is larger than that of the electric motor. Therefore, when the driving state of the hybrid vehicle is switched from the electric motor to the engine, the diving noise of the engine may suddenly occur to reduce the driving quality.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a method for controlling an accelerator pedal of a hybrid vehicle, which increases a pedal effort of an accelerator pedal or applies a vibration or tick to the accelerator pedal when a driving state of the hybrid vehicle is switched from an electric motor to an engine or from the engine to the electric motor, such that a driver easily recognizes the switching of the driving state of the vehicle.

Various aspects of the present invention provide for a method for controlling an accelerator pedal of a hybrid vehicle, including determining a switching state of a driving mode of the hybrid vehicle, and applying a different manipulation feeling to the accelerator pedal, when it is determined that the driving mode was switched.

The different manipulation feeling may include a pedal effort mode for increasing a manipulation pedal effort of the accelerator pedal, a vibration mode for applying a vibration to the accelerator pedal, and a tick mode for applying a tick to the accelerator pedal.

The different manipulation feeling may be implemented by an actuation rod which is installed adjacent to the accelerator pedal so as to come in contact with the accelerator pedal or apply an impact to the accelerator pedal, and an actuator which advances or retreats the actuation rod toward or from the accelerator pedal.

The method may further include sensing the position of the actuation rod and returning the actuation rod to an initial position, after the applying of the different manipulation feeling.

The pedal effort mode may be implemented by the following process: the position of the actuation rod and the manipulation position of the accelerator pedal are sensed, a forward stroke of the actuation rod based on the position of the actuation rod and the manipulation position of the accelerator pedal is calculated, and a control current corresponding to the forward stroke is applied to the actuator to protrude the actuation rod toward the accelerator pedal, such that a manipulation pedal effort is increased by hindrance of the actuation rod during the manipulation of the accelerator pedal.

The vibration mode may be implemented by the following process: the position of the actuation rod and the manipulation position of the accelerator pedal are sensed, forward and backward strokes of the actuation rod based on the position of the actuation rod and the manipulation position of the accelerator pedal are calculated, and control currents corresponding to the forward and backward strokes are applied to the actuator to repetitively advance and retreat the actuation rod toward and from the accelerator pedal, such that repetitive vibrations are applied to the accelerator pedal.

The tick mode may be implemented by the following process: the position of the actuation rod and the manipulation position of the accelerator pedal are sensed, a forward stroke of the actuation rod based on the position of the actuation rod and the manipulation position of the accelerator pedal is calculated, and a control current corresponding to the forward stroke is applied to the actuator to protrude the actuation rod toward the accelerator pedal, such that the actuation rod hits the accelerator pedal.

The method may further include generating a sound or displaying the switching of the driving mode, when the driving mode is switched.

According to the method for controlling an accelerator pedal of a hybrid vehicle, when the driving power source of the hybrid vehicle is switched from the electric motor to the engine or from the engine to the electric motor (hereinafter, referred to the switching of the driving mode), a different manipulation feeling is applied to the accelerator pedal, that is, the manipulation pedal effort of the accelerator pedal is increased or a vibration or tick is applied to the accelerator pedal. Through the different manipulation feeling, the driver may easily recognize the switching of the driving state of the vehicle. Accordingly, the driver may quickly decide whether to drive the hybrid vehicle through the electric motor or the engine, and thus the manipulation of the vehicle is improved.

The mechanism of the intellectual organ-type accelerator pedal which is applied to improve fuel efficiency and collision performance may be used to cause the driver to recognize the switching of the driving mode of the vehicle. Therefore, since a separate signal device or alarm device for informing the driver of the switching of the driving mode does not need to be installed, it is possible to reduce the production cost.

Since a driver preferring the improvement of fuel efficiency or a steady speed operation may be informed of the switching of the driving mode to the engine at the right time, the operation may be continuously performed in the electric motor driving mode preferred by the driver, which makes it possible to increase the merchantability of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a construction diagram of an exemplary intellectual organ-type accelerator pedal device to which a control method according to the present invention is applied.

FIG. 2 is a flow chart of the method for controlling an exemplary accelerator pedal according to the the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

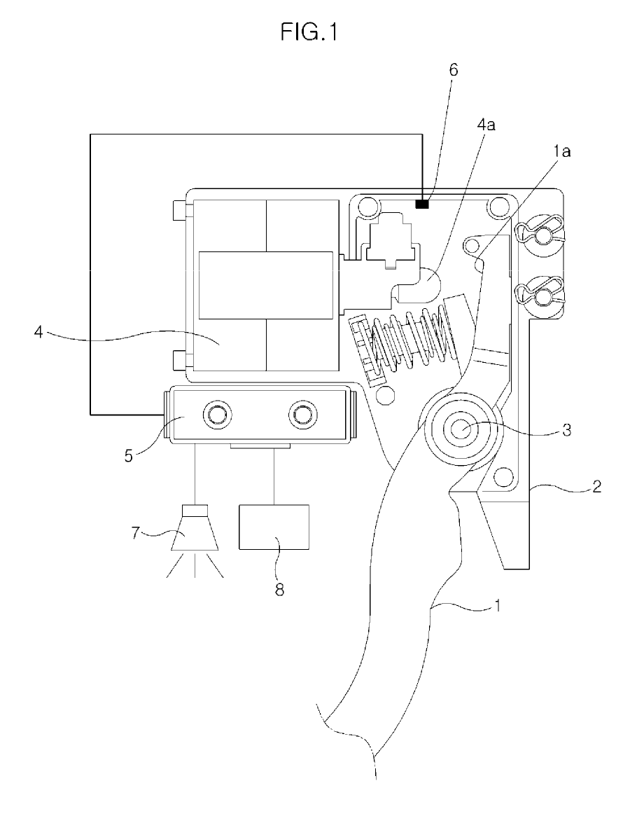

Referring to FIG. 1, an intellectual organ-type accelerator pedal device to which a method for controlling an accelerator pedal according to various embodiments of the present invention is applied includes an accelerator pedal 1 and a housing 2. Accelerator pedal 1 has a structure which is manipulated by a driver's foot, and housing 2 is fixed to a vehicle frame such that accelerator pedal 1 is supported by the vehicle frame. Accelerator pedal 1 is installed in the housing 2 so as to rotate about a hinge shaft 3.

An actuator 4 is installed in housing 2 so as to be adjacent to accelerator pedal 1. Actuator 4 serves to apply a vibration or tick to accelerator pedal 1 or increase the pedal effort of accelerator pedal 1.

An actuation rod 4a protruded toward a leading end portion 1a of accelerator pedal 1, which is housed inside housing 2, is connected to actuator 4 so as to receive an actuation force of actuator 4.

Actuator 4 may be implemented as a solenoid capable of pushing or pulling actuation rod 4a or a linear motor capable of advancing or retreating actuation rod 4a.

When actuation rod 4a is advanced toward leading end portion 1a by actuator 4 and contacted with leading end portion 1a, the motion of leading end portion 1a is hindered by actuation rod 4a during the manipulation of accelerator pedal 1, and thus the pedal effort of accelerator pedal 1 increases.

That is, a pedal effort mode is applied to the accelerator pedal.

When actuation rod 4a is repetitively advanced toward and retreated from leading end portion 1a by actuator 4, actuation rod 4a applies a vibration to accelerator pedal 1, thereby implementing a vibration mode.

When actuation rod 4a is advanced one time toward leading end portion 1a by actuator 4 and hits leading end portion 1a, an impact is applied to accelerator pedal 1, thereby implementing a tick mode.

To control actuator 4 to apply the above-described specific mode to the accelerator pedal, a controller 5 is connected to actuator 4.

According to a control signal applied to actuator 4 from controller 5, actuator 4 is operated to apply a specific mode to accelerator pedal 1.

Housing 2 includes an actuation rod position sensor 6 installed therein, and actuation rod position sensor 6 serves to sense the position of actuation rod 4a and input the sensed position to controller 5. Although not illustrated, a well-known accelerator pedal position sensor capable of sensing the manipulation position of the accelerator pedal may also be connected to the controller, and serves to sense the manipulation position of the accelerator pedal and input the sensed position to the controller.

As actuation rod position sensor 6, a hall sensor may be used, for example.

Meanwhile, an alarm device 7 such as a buzzer to make an alarm or a display 8 to display the driving mode is connected to an output terminal of controller 5. Controller 5 applies a specific mode to the accelerator pedal through the actuator, and simultaneously applies a control signal to alarm device 7 to notify the switching of the driving mode through a sound of alarm device 7. Furthermore, controller 5 may apply a control signal to display 8 to display the current driving mode to a driver.

As controller 5, a well-known hybrid controller may be used. A separate controller may be constructed to apply a control signal indicating a switching state of the driving mode.

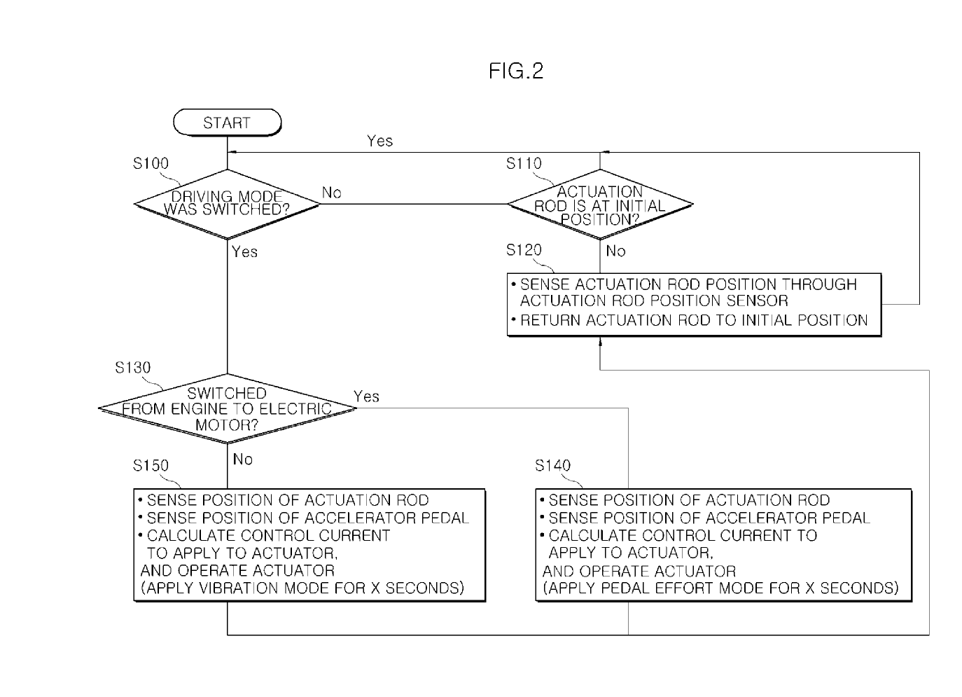

Referring to FIG. 2, the following control logic is programmed in controller 5.

First, controller 5 determines whether the driving state of the hybrid vehicle was switched or not (S100).

When it is determined that the driving mode was not switched, position sensor 6 senses the current position of actuation rod 4a. When actuation rod 4a is not located at the initial position, controller 5 applies a return control signal to actuator 4 and operates actuator 4 to return actuation rod 4a to the initial position (S120).

When it is determined at the step S100 that the driving mode was switched, controller 5 determines whether the driving mode was switched from the engine driving state to the electric motor driving state or not (S130).

When the driving state of the hybrid vehicle is switched from the engine driving state to the electric motor driving state, the position of the actuation rod and the manipulation position of the accelerator pedal are sensed by the position sensors, a forward stroke of the actuation rod based on the manipulation position of the accelerator pedal and the position of the actuation rod is calculated, and a control current corresponding to the forward stroke is applied to the actuator to protrude actuation rod 4a toward leading end portion la of the accelerator pedal. Then, as the manipulation pedal effort is increased by the hindrance of the actuation rod during the manipulation of the accelerator pedal, the pedal effort mode is applied to the accelerator pedal (S140).

Therefore, a driver may easily recognize that the driving state of the hybrid vehicle was switched from the engine driving state to the electric motor driving state, through the increased manipulation pedal effort of the accelerator pedal.

The controller controls actuator 4 such that the pedal effort mode implemented by actuator 4 continues only for X seconds which may be easily recognized by the driver, in order to prevent a reduction in manipulation of the accelerator pedal.

After the above-described pedal effort mode is performed for X seconds, the process returns to the step S120 to return the actuation rod to the initial position.

Meanwhile, when the driving state of the hybrid vehicle is switched from the electric motor to the engine, the position of the actuation rod and the manipulation position of the accelerator pedal are sensed by the position sensors, forward and backward strokes of the actuation rod based on the manipulation position of the accelerator pedal and the position of the actuation rod are calculated, and control currents corresponding to the forward and backward strokes are applied to the actuator to repetitively advance and retreat actuation rod 4a toward and from leading end portion 1a of the accelerator pedal. Then, repetitive vibrations are applied to the accelerator pedal to apply the vibration mode to the accelerator pedal (S150).

Therefore, the driver may easily recognize that the driving state of the hybrid vehicle was switched from the electric motor driving state to the engine driving state, through the vibrations applied to the accelerator pedal.

The controller controls the actuator such that the vibration mode implemented by actuator 4 continues only for X seconds which may be easily recognized by the driver, in order to prevent a reduction in manipulation of the accelerator pedal.

After the above-described vibration mode is performed for X seconds, the process returns to the step S120 to return the actuation rod to the initial position.

Meanwhile, when the driving mode is switched from the engine to the electric motor, the vibration mode may be applied to the accelerator pedal, and when the driving mode is switched from the electric motor to the engine, the pedal effort mode may be applied to the accelerator pedal. Furthermore, the tick mode may be applied to the accelerator pedal during the switching of the driving mode.

The above-described pedal effort mode, vibration mode, or tick mode has a manipulation feeling different from a normal manipulation feeling of the accelerator pedal.

When the above-described specific mode is applied to accelerator pedal 1, alarm device 7 may simultaneously generate a sound or display 8 may simultaneously display the switching of the driving mode. Then, the driver may easily recognize the switching of the driving mode.

As such, when the specific mode is applied to the accelerator pedal such that the driver recognizes a manipulation feeling different from a typical manipulation feeling, the driver may easily recognize the switching of the driving mode of the hybrid vehicle. Therefore, the convenience of the driving manipulation and the merchantability may significantly increase.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling an accelerator pedal of a hybrid vehicle, comprising:
determining a switching state of a driving mode of the hybrid vehicle; and
applying a different manipulation feeling to the accelerator pedal, when it is determined that the driving mode was switched.

2. The method as defined in claim 1, wherein the different manipulation feeling comprises a pedal effort mode for increasing a manipulation pedal effort of the accelerator pedal, a vibration mode for applying a vibration to the accelerator pedal, and a tick mode for applying a tick to the accelerator pedal.

3. The method as defined in claim 1, wherein the driving mode comprises an engine driving mode in which the hybrid vehicle is driven by an engine and an electric motor driving mode in which the hybrid vehicle is driven by an electric motor.

4. The method as defined in claim 2, wherein the different manipulation feeling is implemented by an actuation rod which is installed adjacent to the accelerator pedal so as to come in contact with the accelerator pedal or apply an impact to the accelerator pedal, and an actuator which advances or retreats the actuation rod toward or from the accelerator pedal.

5. The method as defined in claim 4, wherein the actuator comprises a solenoid or linear motor.

6. The method as defined in claim 4, further comprising sensing the position of the actuation rod and returning the actuation rod to an initial position, after the applying of the different manipulation feeling.

7. The method as defined in claim 4, wherein the pedal effort mode is implemented by the following process: the position of the actuation rod and the manipulation position of the accelerator pedal are sensed, a forward stroke of the actuation rod based on the position of the actuation rod and the manipulation position of the accelerator pedal is calculated, and a control current corresponding to the forward stroke is applied to the actuator to protrude the actuation rod toward the accelerator pedal, such that a manipulation pedal effort is increased by hindrance of the actuation rod during the manipulation of the accelerator pedal.

8. The method as defined in claim 4, wherein the vibration mode is implemented by the following process: the position of the actuation rod and the manipulation position of the accelerator pedal are sensed, forward and backward strokes of the actuation rod based on the position of the actuation rod and the manipulation position of the accelerator pedal are calculated, and control currents corresponding to the forward and backward strokes are applied to the actuator to repetitively advance and retreat the actuation rod toward and from the accelerator pedal, such that repetitive vibrations are applied to the accelerator pedal.

9. The method as defined in claim 4, wherein the tick mode is implemented by the following process: the position of the actuation rod and the manipulation position of the accelerator pedal are sensed, a forward stroke of the actuation rod based on the position of the actuation rod and the manipulation position of the accelerator pedal is calculated, and a control current corresponding to the forward stroke is applied to the actuator to protrude the actuation rod toward the accelerator pedal, such that the actuation rod hits the accelerator pedal.

10. The method as defined in claim 1, further comprising generating a sound when the driving mode is switched.

11. The method as defined in claim 1, further comprising displaying the switching of the driving mode when the driving mode is switched.
